(19) United States
(12) Patent Application Publication
(10) Pub. No.: US 2015/0078734 A1
(43) Pub. Date: Mar. 19, 2015

(54) DISPLAY APPARATUS AND CONTROLLING METHOD THEREOF

(71) Applicant: SAMSUNG ELECTRONICS CO., LTD., Suwon-si (KR)

(72) Inventors: Eun-Jong YOO, Suwon-si (KR); Young-jai BAI, Suwon-si (KR)

(73) Assignee: SAMSUNG ELECTRONICS CO., LTD., Suwon-si (KR)

(21) Appl. No.: 14/333,558

(22) Filed: Jul. 17, 2014

(30) Foreign Application Priority Data
Sep. 16, 2013 (KR) 10-2013-0111214

(51) Int. Cl. G11B 27/10; H04N 9/87; H04N 5/93

(52) U.S. Cl. CPC G11B 27/105; H04N 5/93; H04N 9/87
USPC 386/349

(57) ABSTRACT

A display apparatus is provided. The apparatus for displaying a video content includes an input part configured to receive a pause command, an image processor configured to stop reproducing the video content and display a still image at a pause time on a display in response to the pause command being input, and a controller configured to control the image processor to sequentially change the still image displayed on the display to another still image in response to an image change command being input while the still image is being displayed.

### CROSS-REFERENCE TO RELATED APPLICATIONS

This application claims priority from Korean Patent Application No. 10-2013-0111214, filed in the Korean Intellectual Property Office on Sep. 16, 2013, the entire disclosure of which is hereby incorporated by reference.

### BACKGROUND

1. Field

Aspects of the exemplary embodiments relate to a display apparatus and a controlling method thereof. In particular, exemplary embodiments relate to a display apparatus which generates an interpolated frame and a controlling method thereof.

2. Description of the Related Art

With the development of electronic technologies, various types of electronic apparatuses have been developed and distributed. In particular, various display apparatuses, such as TV, mobile phone, PC, notebook PC, PDA, etc., are widely used in general household.

User needs have also increased for various functions. Accordingly, in an effort to satisfy the increased user needs, manufacturers are introducing display apparatuses which include new functions.

As a result, functions supported by such display apparatuses have become diverse. In particular, a related art display apparatus is capable of displaying a natural motion by converting a frame rate when reproducing a video.

However, in a case of a still image at a specific point of time while a video is reproduced, it is impossible to display a screen of an interpolated frame where a frame rate is changed.

Thus, there is a need to provide a user with a desired image by displaying an interpolated frame, when a frame rate is changed between still images, to observe a specific scene while a video is reproduced.

### SUMMARY

An aspect of the exemplary embodiments relates to a display apparatus which generates an interpolated frame and a controlling method thereof.

According to an aspect of the exemplary embodiments, there is provided an apparatus for displaying a video content which includes an input part configured to receive a pause command, an image processor configured to stop reproducing the video content and display a still image at a pause time on a display in response to the pause command being input, and a controller configured to control the image processor to sequentially change the still image displayed on the display to another still image in response to an image change command being input while the still image is being displayed. The apparatus may also include the display configured to display the video content.

The image processor may convert a frame rate of the video content by inserting at least one interpolated frame between original frames of the video content, and the controller may display an original frame as a still image corresponding to a time when the pause command is input, and may display a previous interpolated frame or a next interpolated frame of the displayed original frame in response to the image change command being input.

The controller may control the image processor to reproduce at least one frame which is disposed after the previous interpolated frame or the next interpolated frame in response to a content reproduction command being input while the previous interpolated frame of the next interpolated frame is displayed.

The display may display a bar indicator which indicates a reproduction progress of the video content on one side of the still image, and the controller may display an original frame as the still image corresponding to the selected point of a plurality of original frames included in the video content in response to a point being selected on the bar indicator.

The controller may change the still image displayed on the display to another still image which is disposed before or after the displayed still image by a predetermined number of frames in response to the image change command being input.

The controller may change the predetermined number of frames according to a user setting.

According to an aspect of the exemplary embodiments, there is provided a method for controlling a display apparatus which includes displaying a video content stopping reproducing the video content and displaying a still image at a pause time on a display in response to a pause command being input, and sequentially changing the still image displayed on the display to another still image in response to an image command being input while the still image is being displayed.

The method may further include converting a frame rate of the video content by inserting at least one interpolated frame between original frames of the video content, and the sequentially changing the still image displayed on the display to another still image may include, displaying an original frame as a still corresponding to a time when the pause command is input in response to the passé command being input, and displaying a previous interpolated frame or a next interpolated frame of the displayed original frame in response to the image change command being input.

The method may further include reproducing at least one frame which is disposed after the previous interpolated frame or the next interpolated frame in response to a content reproduction command being input while the previous interpolated frame or the next interpolated frame is displayed.

The sequentially changing to the still image displayed on the display to another still image may include displaying an original frame as the still image corresponding to a selected point of a plurality of original frames included in the video content in response to a point being selected on a bar indicator.

The sequentially changing the still image displayed on the display to another still image may include changing the still image displayed on the display to another still image which is disposed before or after the displayed still image by a predetermined number of frames in response to the image change command being input.

The sequentially changing the still image displayed on the display to another still image may include changing the predetermined number of frames according to a user setting.

According to an aspect of the exemplary embodiments, there is provided an apparatus for displaying a video content which includes an input part configured to receive a pause command, an image processor configured to stop reproducing the video content and display a still image at a pause time on a display in response to the pause command being input, and a controller configured to control the image processor to display one of a previous interpolated frame and a next interpolated frame of the still image in response to an image change command being input to the display.

According to the various exemplary embodiments, a display apparatus may generate and display an interpolated frame between frames of a still image.

### BRIEF DESCRIPTION OF THE DRAWINGS

The above and/or other aspects of the exemplary embodiments will be more apparent by describing certain exemplary embodiments with reference to the accompanying drawings, in which:

FIG. 1 is a block diagram illustrating configuration of a display apparatus according to an exemplary embodiment;

FIG. 2 is a block diagram illustrating a user interface to receive an image change command according to an exemplary embodiment;

FIG. 3 is a view provided to explain a process of displaying an interpolated frame in accordance with an image change command according to an exemplary embodiment;

FIGS. 4 to 6 are views illustrating a process of reproducing an original frame and an interpolated frame according to an exemplary embodiment;

FIG. 7 is a view illustrating a method of reproducing a still image using an indicator according to an exemplary embodiment; and

FIG. 8 is a flowchart provided to explain a method of controlling a display apparatus according to an exemplary embodiment.

### DETAILED DESCRIPTION OF THE EXEMPLARY EMBODIMENTS

It should be observed that the method steps and system components have been represented by related art symbols in the figures and specific details which are relevant for an understanding of the exemplary embodiments. Further, additional details not disclosed may be readily apparent to a person of ordinary skill in the art may. In the exemplary embodiments, relational terms such as first and second, etc., may be used to distinguish one entity from another entity, without necessarily implying any actual relationship or order between such entities.

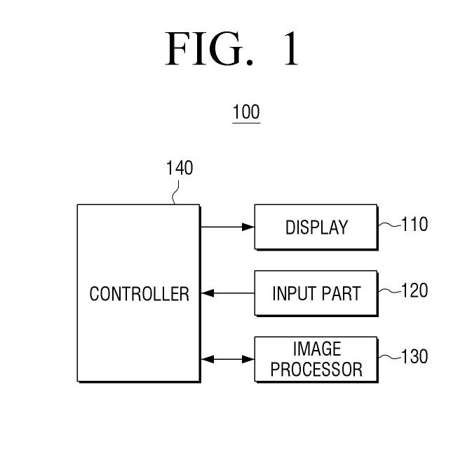

FIG. 1 is a block diagram illustrating configuration of a display apparatus according to an exemplary embodiment.

According to FIG. 1, a display apparatus 100 includes a display 110, an input part 120, an image processor 130, and a controller 140. The display apparatus 100 may be realized as various types of electronic apparatuses, such as TV, electronic black board, electronic table, Large Format Display (LFD), smart phone, tablet, desktop PC, notebook PC, etc.

In addition, the display 110 may display video contents. The video contents may include all video images which consist of a plurality of images, such as movie, drama, recorded image, slow vide, etc., and can be displayed with a certain frame rate.

The display 110 may display objects such as still image, photo, document, etc.

The display 110 may be realized as Liquid Crystal Display (LCD), Organic Light Emitting Display (OLED) or Plasma Display Panel (PDP).

The input part 120 may receive a pause command.

Further, the input part 120 may receive a user command to switch channels, adjust volume, etc., and the controller 140 may switch channels or adjust volume according to the input user command.

The input part 120 may be realized as an input panel. The input panel may be realized as a touch pad, a key pad, or a touch screen having various function keys, number keys, special keys, text keys, etc.

When a pause command is input, the image processor 130 may stop reproducing a video content and display a still image at the time when the reproduction of the content is stopped on the display 110.

In particular, when a pause command is input through the input part 120, the image processor 130 may stop a video content which has been displayed on the display 110, and display a still image at the time when the reproduction of the content is stopped on the display 110.

The still image at the time when the reproduction of the content is stopped refers to one of a plurality of images which constitute the video content.

For example, the image processor 130 may realize a video content having a frame rate of 30 Hz by displaying 30 images per one second. In other words, the image processor 130 may display a video of one second by displaying 30 images sequentially for one second. In this case, when a pause command is input through the input part 120 (it is assumed that the pause command is input within one second), the image processor 130 may stop reproducing the video content and display a still image at the time when the reproduction of the content is stopped, i.e., one of the 30 images on the display 110.

As the image processor 130 displays the still image at the time when the reproduction of the content is stopped, i.e., one image of the 30 continuous images for one second, a user may watch the same image 30 times for one second. In other words, the user may watch the still image for one second.

The controller 140 may control overall operations of the display apparatus 100. Further, the controller 140 may include a central processing unit (CPU) and a Random Access Memory (RAM) for operations of the display apparatus 100.

In particular, when an image change command is input while a still image is displayed, the controller 140 may control the image processor 130 to sequentially change the still image displayed on the display 110 to another still image whenever the image change command is input.

The image change command is a command that is input to change a still image, at a time when the display of a content is stopped in response to the pause command being input to anther still image.

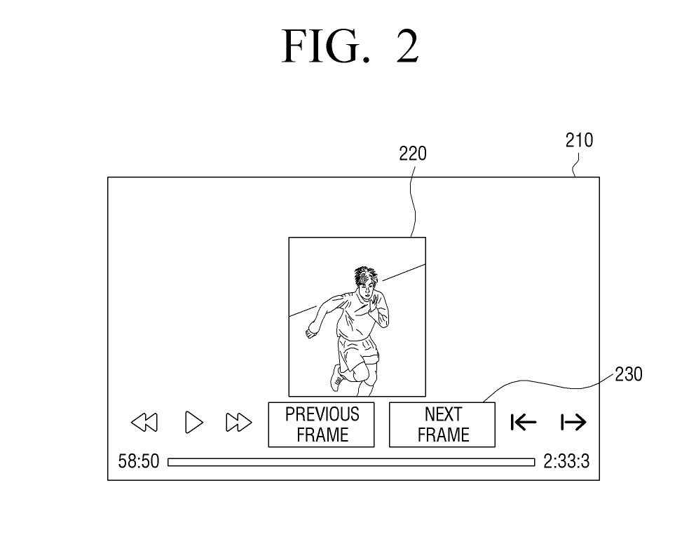

For example, as illustrated in FIG. 2, the image change command may be input through an icon 230 which is displayed as “next frame” to change the current still image to the next still image on the display 210 while a still image 220 is displayed.

In addition, although not illustrated in FIG. 2, the image change command may be input through a graphic user interface such as an arrow, or through a button key displayed as “next frame” on a remote controller (not shown).

Whenever the image change command is input while a still image is displayed, i.e., whenever the image change command is input through the icon 230 which is displayed as “next frame” or a graphic user interface such as the controller 140 as illustrated in FIG. 2, the controller 140 may control the image processor 130 to sequentially change a still image displayed on the display 210 to a still image of the next frame.

The still image of the next frame refers to a still image of a frame which comes after the still image at the time when the display of a content is stopped.

For example, the pause command may be input while an image having the frame rate of 30 Hz is displayed sequentially (herein, it is assumed that the pause command is input within one second), and a still image at the selected pause time may be displayed. In this case, the still image at the pause time may be the 15th image from among the 30 images.

If the image change command is input through the icon 230 which is displayed as “next frame” while the 15th image is displayed, the controller 140 may display the 16th image as a still image.

The image processor 130 may convert a frame rate of a video content by inserting at least one interpolated frame between original frames of the video content.

The frame rate is a rate of speed by which successive images are photographed or reproduced. The frame rate may be measured by the number of frames for each second, such as 24 frames per each second of a film or 30 frames per each second of a video.

The frame rate may be the number of frames that a transmitter transmits for each second. When an image signal such as a TV signal is transmitted, the number of screens (frames) to be transmitted per second may be decided in consideration of visual characteristics of a user. For example, in a related art color TV, the frame rate in NTSC method is 30 frames per second, and the frame rate in PAL and SECAM methods is 25 frames per second.

The Frame Rate Control (FRC) refers to a method of implementing higher color quality in a display panel having low color resolution such as LCD, and is also referred to as color representation control. This scheme, which disperses smaller number of colors, aims to represent more colors than the original colors.

The image processor 130 may calculate the scale of an average motion vector between adjacent two frames from among a certain number of frames which are input sequentially, determine a frame section corresponding to a maximum value from among the calculated scales of average motion vectors between two frames, and generate a new frame, i.e., an interpolated frame, by motion compensation of a certain rate in the frame section having the maximum motion vector.

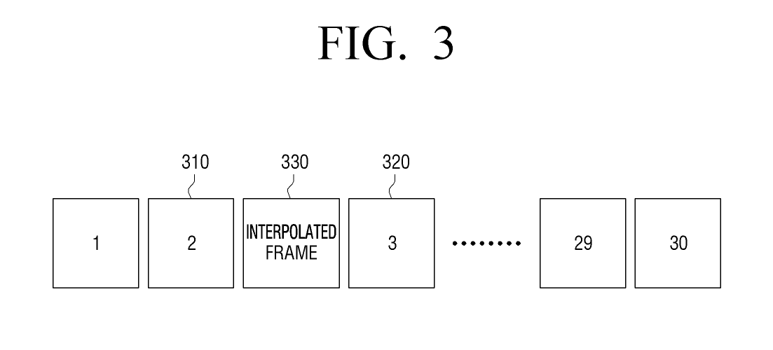

In particular, based on information regarding the frame section having the maximum motion vector, a new interpolated frame where a certain motion compensation rate is applied may be generated between input frames. For example, as illustrated in FIG. 3, if there is a maximum motion vector between frame 2 (310) and frame 3 (320), the image processor 130 may composite an interpolated frame 330 where the motion of a motion vector which moves from the frame 2 (310) to the frame 3 (320) is compensated as much as ½ and the motion of a motion vector which moves from the frame 3 (320) to the frame 2 (310) is compensated as much as ½. In this case, the composite interpolated frame 330 may be inserted as a new frame between the frame 2 (310) and the frame 3 (320).

Further, when the pause command is input, the controller 140 may display the original frame corresponding to the point of time when the command is input as a still image. When the image change command is input (after the pause command is input), the controller 140 may display the previous or the next interpolated frame of the displayed original frame. Further details will be explained with reference to FIG. 3.

FIG. 3 is a view provided to explain a process of displaying an interpolated frame in accordance with an image change command according to an exemplary embodiment.

Referring to FIG. 3, when a video content is displayed on the display 110, the controller 140 may display frames 1, 2, 3, . . . , 29, and 30 sequentially. When the pause command is input, the image processor 130 may stop reproducing the video content and display a still image at the pause time on the display 110. In this case, if it is assumed that the still image at the pause time is the frame 2 (310), the image processor 130 may display the frame 2 (310) when the pause command is input.

Further, when the image change command is input while the frame 2 (310) is displayed as a still image, the controller 140 may display the next interpolated frame of the displayed original frame, i.e., the frame 2 (310).

Accordingly, when a user inputs the pause command to stop reproducing a video content and inputs the image change command while the frame 2 is displayed as a still image, the controller 140 displays the interpolated frame 330, instead of the frame 3, as a still image.

Further, if the frame rate of a video content is 30 Hz, the frame rate of the interpolated frame 330 may be 60 Hz. Thus a user may watch an image with a higher frame rate, and watch an image which is omitted from the original frame as a still image.

In FIG. 3, it is illustrated that the controller 140 displays the next interpolated frame 330 of the still image 310 at the pause time, but the controller 140 may display the next interpolated frame 330 of the still image 310 at the pause time or the previous interpolated frame (not shown) of the still image 310 at the pause time, depending on whether the image change command is to display the next frame of the previous frame.

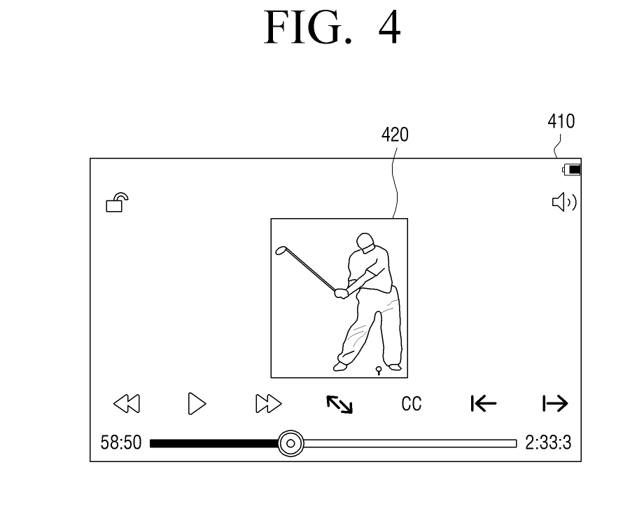

When a content reproduction command is input while the previous or the next interpolated frame is displayed, the controller 140 may control the image processor 130 to reproduce frames from the next frame of the previous or the next interpolated frame, which will be described in detail with reference to FIGS. 4 to 6. The content reproduction command may be input through at least one of the display 110 or the input part 120.

FIGS. 4 to 6 are views illustrating a process of reproducing an original frame and an interpolated frame according to an exemplary embodiment.

Referring to FIG. 4, the display 110 displays a still image 420 at a pause time according to a pause command. As described above, when the pause command is input through the input part 120, the image processor 130 may stop displaying a video content which has been displayed on the display 410 and display the still image 420 at the pause time on the display 410.

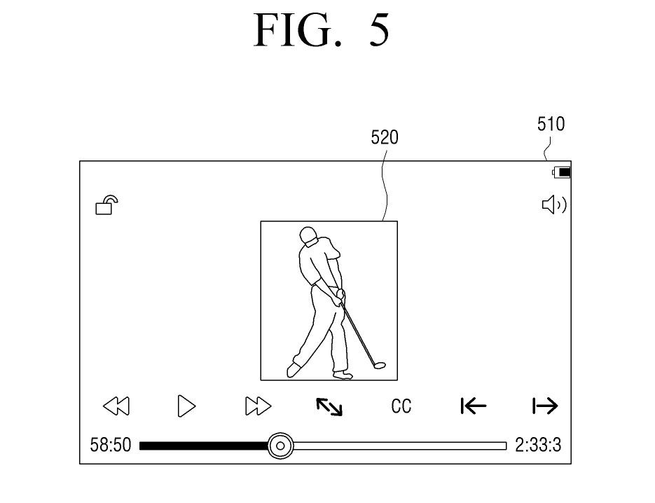

The image processor 130 may convert a frame rate of a video content by inserting at least one interpolated frame between original frames of the video content. Referring to FIG. 5, when an image change command is input while the still image at the pause time according to the pause command in FIG. 4 is displayed, the controller displays the next interpolated frame 520 of the still image 420 at the pause time on the display 510.

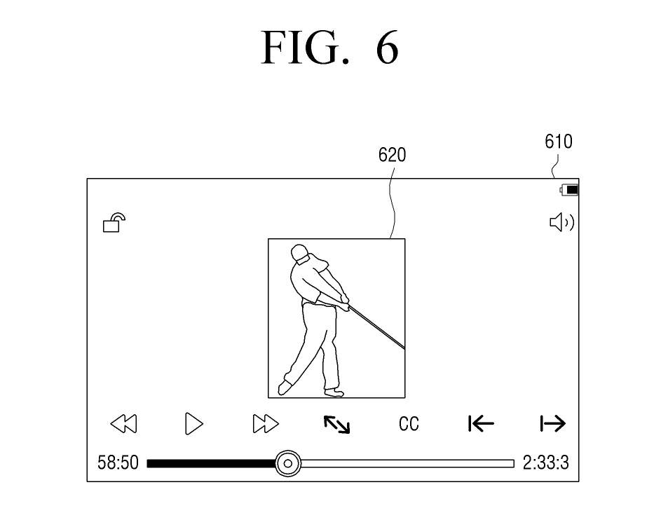

In addition, as illustrated in FIGS. 5-6, when a content reproduction command is input while the next interpolated frame 520 is displayed, the controller 140 may display the next original frame 620 which comes after the next interpolated frame 520 on a display 610.

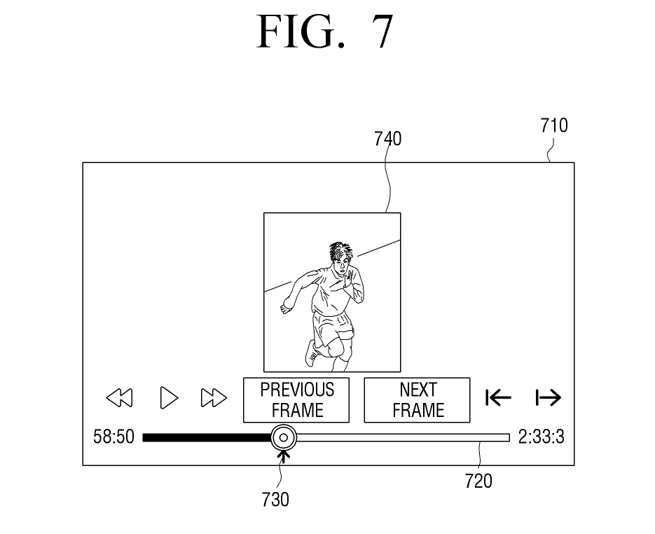

FIG. 7 is a view illustrating a method of reproducing a still image using an indicator according to an exemplary embodiment.

Referring to FIG. 7, a display 710 may display a bar indicator 720 which indicates the reproduction progress of a video content on one side of a still image.

In addition, when a certain point is selected on the displayed bar indicator 720, the controller 140 may display an original frame 740, corresponding to the selected point 730 from among a plurality of original frames included in the video content on the display 710, as a still image.

In particular, when a certain point is selected on the displayed bar indicator 720 displayed on one side of a still image while a still image at a pause time is displayed according to a pause command, the controller 140 may display an original frame 740, corresponding to the selected point 730 from among a plurality of original frames included in the video content on the display 710, as a still image.

In addition, when the image change command is input, the controller 140 may change the displayed still image to another still image which is disposed before or after the displayed still image by the predetermined number of frames.

For example, when the image change command to change a still image to another still image which comes 5 frames after the still image, the display 110 may change the displayed still image to another still image which is disposed 5 frames after the displayed still image.

Further, when a user sets a still image to be changed to another still image which comes 10 frames after the still image, the controller 140 may change the still image displayed on the display 110 to another still image which is disposed 10 frames after the displayed still image even if the user inputs the image change command only once. If the user inputs the image change command twice in a row, the still image displayed on the display 110 may be changed to another still image which is disposed 20 frames after the displayed still image.

Accordingly, the controller 140 may change the number of frames according to the user setting.

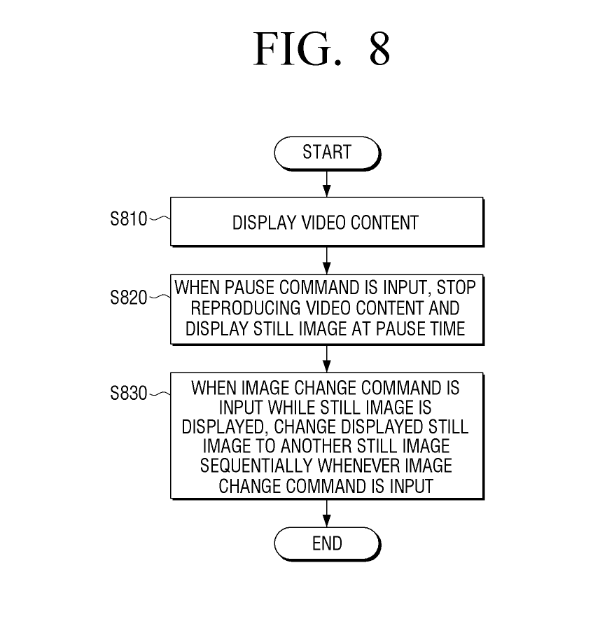

FIG. 8 is a flowchart provided to explain a method of controlling a display apparatus according to an exemplary embodiment.

According to the method illustrated in FIG. 8, a video content may be displayed (S810).

When a pause command is input, the reproduction of the video content may be stopped, and a still image at the pause time may be displayed (S820).

Further, whenever an image change command is input while a still image is displayed, the still image displayed on the display may be sequentially changed to another still image (S830).

Meanwhile, the method illustrated in FIG. 8 may further include converting a frame rate of a video content by inserting at least one interpolated frame between original frames of the video content.

The sequentially changing to another still image may include, when a pause command is input, displaying an original frame corresponding to the pause time as a still image, and when an image change command is input, displaying the previous or the next interpolated frame of the displayed original frame.

In addition, the sequentially changing to another still image may further include, when a content reproduction command is input while the previous or the next interpolated frame is displayed, reproducing frames from an original frame which is disposed after the previous or the next interpolated frame.

The sequentially changing to another still image may include, when a certain point is selected on a bar indicator which indicates the reproduction progress of a video content displayed one side of a still image, displaying an original frame corresponding to the selected point from among a plurality of original frames included in the video content as a still image.

The sequentially changing to another still image may include, when an image change command is input, changing the displayed still image to another still image which is before or after the displayed still image by the predetermined number of frames.

Further, the sequentially changing to another still image may include changing the number of frames according to the user setting.

Meanwhile, a non-transitory computer readable medium storing a program to sequentially perform the controlling method according to an exemplary embodiment may be provided.

For example, a non-transitory computer readable medium which stores a program to perform the operations of displaying a video content, when a pause command is input, stopping reproduction of the video content and displaying a still image at the pause time. Further, when an image change command regarding a still image at the pause time is input (after the pause command is input), changing the displayed still image to another still image sequentially may be provided.

In another example, a non-transitory computer readable medium which stores a program to perform the operations of converting a frame rate of a video content by inserting at least one interpolated frame between original frames of the video content, and when a content reproduction command is input while the previous or the next interpolated frame is displayed, reproducing frames from the original frame which is disposed after the previous or the next interpolated frame may be provided.

The non-transitory recordable medium refers to a medium which may store data semi-permanently rather than storing data for a short time such as a register, a cache, and a memory and may be readable by an apparatus. Specifically, the above-mentioned various applications or programs may be stored in a non-temporal recordable medium such as CD, DVD, hard disk, Blu-ray disk, USB, memory card, and ROM and provided therein.

In addition, although a bus is not illustrated in the above-described block diagram regarding a display apparatus, communication between each element of the display apparatus may be performed through a bus. In addition, each device may further include a processor such as a CPU which performs various operations mentioned above and a microprocessor.

The foregoing embodiments and advantages are merely exemplary and are not to be construed as limiting the exemplary embodiments. The present teaching can be readily applied to other types of apparatuses. Also, the description of the exemplary embodiments is intended to be illustrative, and not to limit the scope of the claims. Many alternatives, modifications, and variations will be apparent to those skilled in the art.

What is claimed is:

1. An apparatus for displaying a video content comprising:
an input part configured to receive a pause command;
an image processor configured to stop reproducing the video content and display a still image at a pause time on a display in response to the pause command being input; and
a controller configured to control the image processor to sequentially change the still image displayed on the display to another still image in response to an image change command being input while the still image is being displayed.

2. The apparatus as claimed in claim 1, wherein the image processor converts a frame rate of the video content by inserting at least one interpolated frame between original frames of the video content,
wherein the controller displays an original frame as a still image corresponding to a time when the pause command is input, and displays a previous interpolated frame or a next interpolated frame of the displayed original frame in response to the image change command being input.

3. The apparatus as claimed in claim 2, wherein the controller controls the image processor to reproduce at least one frame which is disposed after the previous interpolated frame or the next interpolated frame in response to a content reproduction command being input while the previous interpolated frame or the next interpolated frame is displayed.

4. The apparatus as claimed in claim 2, wherein the display displays a bar indicator which indicates a reproduction progress of the video content on one side of the still image,
wherein the controller displays an original frame as the still image corresponding to a selected point of a plurality of original frames included in the video content in response to a point being selected on the bar indicator.

5. The apparatus as claimed in claim 1, wherein the controller changes the still image displayed on the display to another still image which is disposed before or after the displayed still image by a predetermined number of frames in response to the image change command being input.

6. The apparatus as claimed in claim 5, wherein the controller changes the predetermined number of frames according to a user setting.

7. A method for controlling a display apparatus comprising:
displaying a video content;
stopping reproducing the video content and displaying a still image at a pause time on a display in response to a pause command being input; and
sequentially changing the still image displayed on the display to another still image in response to an image command being input while the still image is being displayed.

8. The method as claimed in claim 7, further comprising:
converting a frame rate of the video content by inserting at least one interpolated frame between original frames of the video content,
wherein the sequentially changing the still image displayed on the display to another still image comprises:
displaying an original frame as a still corresponding to a time when the pause command is input in response to the pause command being input, and
displaying a previous interpolated frame or a next interpolated frame of the displayed original frame in response to the image change command being input.

9. The method as claimed in claim 8, further comprising:
reproducing at least one frame which is disposed after the previous interpolated frame or the next interpolated frame in response to a content reproduction command being input while the previous interpolated frame or the next interpolated frame is displayed.

10. The method as claimed in claim 8, wherein the sequentially changing the still image displayed on the display to another still image comprises displaying an original frame as the still image corresponding to a selected point of a plurality of original frames included in the video content in response to a point being selected on a bar indicator.

11. The method as claimed in claim 7, wherein the sequentially changing the still image displayed on the display to another still image comprises changing the still image displayed on the display to another still image which is disposed before or after the displayed still image by a predetermined number of frames in response to the image change command being input.

12. The method as claimed in claim 11, wherein the sequentially changing the still image displayed on the display to another still image comprises changing the predetermined number of frames according to a user setting.

13. An apparatus for displaying a video content comprising:
an input part configured to receive a pause command;
an image processor configured to stop reproducing the video content and display a still image at a pause time on a display in response to the pause command being input; and
a controller configured to control the image processor to display one of a previous interpolated frame and a next interpolated frame of the still image in response to an image change command being input to the display.

14. The apparatus according to claim 13, wherein the previous interpolated frame is inserted between the still image and a first frame before the still image.

15. The apparatus according to claim 13, wherein the next interpolated frame is inserted between the still image and a second frame after the still image.

16. The apparatus according to claim 13, wherein the controller is further configured to display a third image which is a next frame after one of the previous interpolated frame and the next interpolated frame in response to a content reproduction command being input.

17. The apparatus according to claim 13, wherein the image processor converts a frame rate of the video content by inserting the one of the previous interpolated frame and the next interpolated frame in the video content.

18. The apparatus according to claim 13, further comprising:
the display configured to display the video content.

19. The apparatus according to claim 1, further comprising:
the display configured to display the video content.
